(19) United States
(12) Patent Application Publication
(10) Pub. No.: US 2008/0310732 A1
(43) Pub. Date: Dec. 18, 2008

(54) Contour Recovery of Occluded Objects in Images

(75) Inventors: Rui Pedro Amaral Rodrigues, Porto (PT); Fabian Edgar Ernst, Eindhoven (NL); Cornelius Wilhelmus Antonius Marie Van Overveld, Eindhoven (NL); Antonio Jose Borba Ramires Fernandes, Braga (PT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,382

(22) PCT Filed: Dec. 7, 2004
(86) PCT No.: PCT/IB2004/052683

§ 371 Date: Jun. 12, 2006

(30) Foreign Application Priority Data
Dec. 15, 2003 (EP) 03104693.1

(51) Int. Cl. G06T 7/00

(52) U.S. Cl. 382/203

(57) ABSTRACT

The present invention relates to a method, apparatus and computer program product for providing contour information related to images. An image obtaining unit obtains a set of interrelated images (step 26), an image segmenting unit segments said images, (step 28) and a contour determining unit (22) extracts at least two contours from the segmentation (step 30), selects interest points on the contours of each image (step 32), associates interest points with corresponding reconstructed points by means of three-dimensional reconstruction (step 34), projects reconstructed points into the images (step 36), and links reconstructed points not projected at a junction or their projections to each other in order to provide a first set of links (step 38), such that at least a reasonable part of a contour of an object can be determined based on the linked reconstructed points.

### TECHNICAL FIELD

The present invention generally relates to the field of simplifying coding of objects in images and then more particularly towards a method, apparatus and computer program product for providing contour information related to images.

### Acknowledgement

Philips thanks the University do Minho from Portugal for their cooperation in making the filing of this patent application possible.

### DESCRIPTION OF RELATED ART

In the field of computer generated images and video there has been a lot of work regarding the generation of three-dimensional models out of two-dimensional images in order to further enhance scene visualisation. Areas where such things are of interest are in the field of three-dimensional TV projection. All this is possible if there is sufficient information in the two dimensional images that can be used to determine the distance of objects from a point where the image is captured.

Today there exist different such means such as measuring the apparent displacement of objects between image pairs and using information about the camera used to compute that distance. For translation settings then the faster the movement is the closer the object is to the capturing point. However in doing this objects will often be occluded, i.e. be blocked by other objects, which means that it is hard to determine the actual shape or contour of an object.

Such complete or almost complete contours are good to have for all objects in order to simplify the coding of these images, like when performing video coding according to different standards, such as the MPEG4 standard.

There exist some ways of solving this problem of providing further information regarding occluded objects. One way is the edge continuation method, which is for instance described in “An Empirical Comparison of Neural Techniques for Edge Linking of Images”, by Stuart J. Gibson and Robert I. Damper in Neural Computing & Applications, Version 1, Oct. 22, 1996.

However these ways are based on heuristics and may link part of a scene for which there is no visual evidence of connectivity. There is also in many cases a need for large and complicated computations, because it can be hard to discern if an object occludes another, i.e. where there is a junction between the contours of objects in a number of images.

There is therefore a need for a solution that enables the determination of a complete or almost complete contour for an object in a number of images when the whole or most of the contour can be deducted from the images, but is not completely visible in any of the images.

### SUMMARY OF THE INVENTION

It is therefore an object of the present invention to enable determination of a complete or almost complete contour for an object in a number of images when the whole or most of the contour can be deducted by combining information from a set of images, but is not completely visible in any of the images.

According to a first aspect of the present invention, this object is achieved by a method of providing contour information related to images, comprising the steps of:
obtaining a set of interrelated images,
segmenting said images,
extracting at least two contours from the segmentation,
selecting interest points on at least some of the contours,
associating, for said extracted contours, interest points with corresponding reconstructed points by means of three-dimensional reconstruction,
projecting the reconstructed points into each image, and
linking, for each image, reconstructed points that are not projected at a junction point between different contours or their projections to each other in order to provide a first set of links, such that at least a reasonable part of a contour of an object can be determined based on the linked points.

According to a second aspect of the invention, this object is also achieved by an apparatus for providing contour information related to images, comprising:
an image obtaining unit arranged to obtain a set of interrelated images, and
an image segmenting unit arranged to segment said images, and
a contour determining unit arranged to:
   extract at least two contours from the segmentation made by the segmentation unit,
   select interest points on the contours of each image,
   associate, for each extracted contour, interest points with corresponding reconstructed points by means of three-dimensional reconstruction,
   project the reconstructed points into each image, and
   link, for each image, reconstructed points that are not projected at a junction between different contours or their projections to each other in order to provide a first set of links, such that at least a reasonable part of a contour of an object can be determined based on the linked points.

According to a third aspect of the present invention, this object is also achieved by a computer program product for providing contour information related to images, comprising a computer readable medium having thereon:

computer program code means, to make the computer, when said program is loaded in the computer:
obtain a set of interrelated images,
segment said images,
extract at least two contours from the segmentation,
select interest points on at least some of the contours,
associate, for said extracted contours, interest points with corresponding reconstructed points by means of three-dimensional reconstruction,
project the reconstructed points into each image, and
link, for each image, reconstructed points that are not projected at a junction point between different contours or their projections to each other in order to provide a first set of links, such that at least a reasonable part of a contour of an object can be determined based on the linked points.

Advantageous embodiments are defined in the dependent claims.

The present invention has the advantage of enabling the obtaining of a complete or almost complete contour of an object even if the whole object is not visible in any of the related images. It suffices that all the different parts of it can be obtained from the totality of the images. The invention furthermore enables the limitation of the number of points used for determining a contour. This makes it possible to keep the computational power needed for determining a contour fairly low. The invention is furthermore easy to implement, since all points are treated in a similar manner. The invention is furthermore well suited for combining with image coding methods like for instance MPEG4.

The general idea behind the invention is thus to segment a set of interrelated images, extract contours from the segmentation, select interest points on the contours, associate interest points with corresponding reconstructed points, determine the movement of the contours from image to image, project the reconstructed points into the images at positions decided by the movement of the contour, and link for each image, reconstructed points that are not projected at a junction point between different contours to each other. In this way a first set of links can be provided such that at least a reasonable part of a contour of an object can be determined based on the linked reconstructed points.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where FIG. 1A shows a first image where a number of junction points have been detected between different objects that overlap each other,

FIG. 1B shows a second image showing the same objects as in FIG. 1A, where the objects have moved in relation to each other and where a number of different junction points have been detected,

FIG. 1C shows a third image showing the same objects as in FIGS. 1A and B, where the objects have moved further in relation to each other and where a number of junction points have been detected,

FIG. 2A shows the first image where reconstructed points corresponding to all junction points of the three images have been projected into the image,

FIG. 2B shows the second image where reconstructed points corresponding to all junction points of the three images have been projected into the image,

FIG. 2C shows the third image where reconstructed points corresponding to all junction points of the three images have been projected into the image,

FIG. 3A shows the projected reconstructed points of FIG. 2A, where the points have been linked in a first and second set of links,

FIG. 3B shows the projected reconstructed points of FIG. 2B, where the points have been linked in a first and second set of links,

FIG. 3C shows the projected reconstructed points of FIG. 2C, where the points have been linked in a first and second set of links,

FIG. 4A shows the reconstructed points in the first set of links of FIG. 3A,

FIG. 4B shows the reconstructed points in the first set of links of FIG. 3B,

FIG. 4C shows the reconstructed points in the first set of links of FIG. 3C,

FIG. 4D shows the combined first set of links from FIG. 4A-C, in order to provide a complete contour for two of the objects,

FIG. 5 shows a block schematic of a device according to the present invention,

FIG. 6 shows a flow chart for performing a method according to the present invention, and

FIG. 7 shows a computer program product comprising program code for performing the method according to the invention.

### DETAILED DESCRIPTION OF EMBODIMENTS

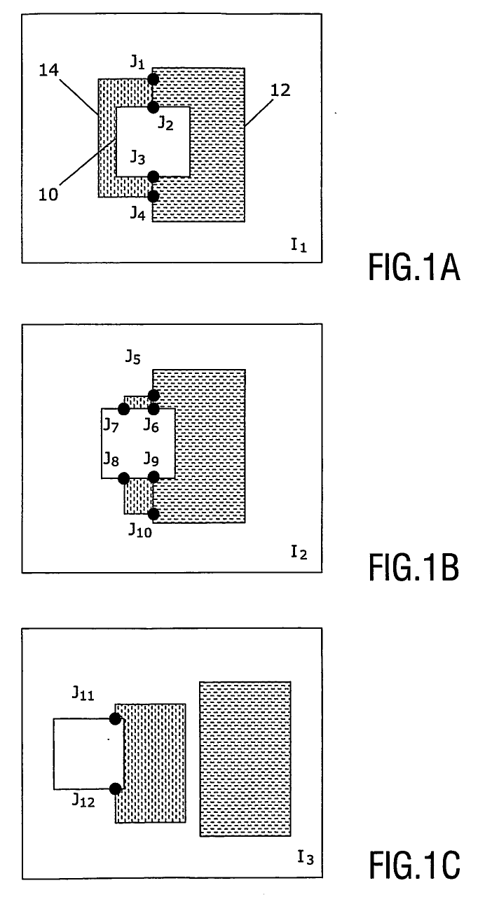

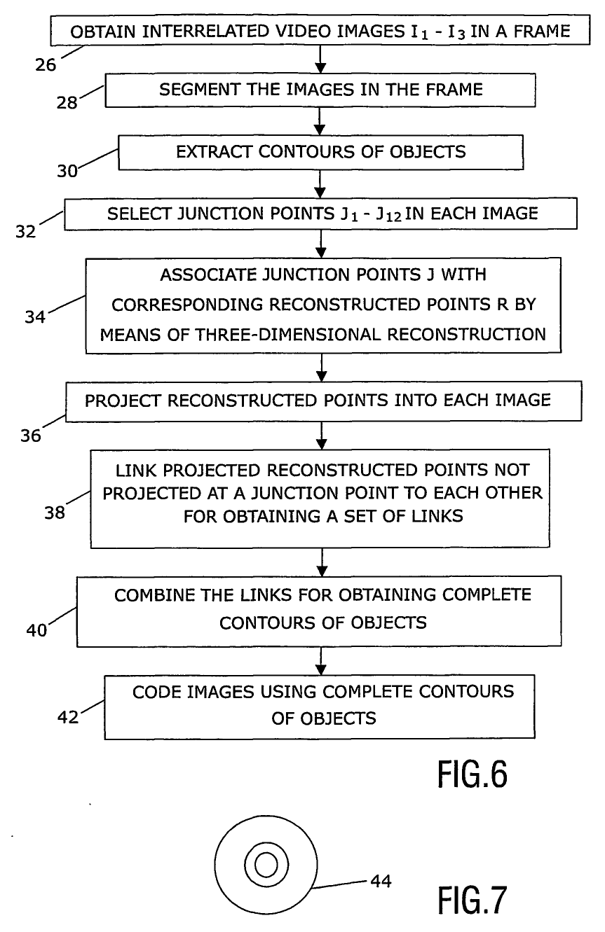

The present invention will now be described in relation to the enclosed drawings, with reference first being made to FIG. 1A-C, showing a number of images, FIG. 5 showing a block schematic of a device according to the invention and FIG. 6 showing a flow chart of a method according the invention. The device 16 in FIG. 5 includes a camera 18, which captures interrelated images in a number of frames. For better explaining the invention only three I₁, I₂ and I₃ of a static scene captured by a camera from three different angles for a frame are shown in FIG. 1A-C. The camera thus obtains the images by capturing them, step 26, and then forwards them to an image segmenting unit 20. The image segmenting unit 20 segments the images in the frame, step 28. Segmentation is in this exemplary embodiment done through analysing the colour of the images, where areas having the same colour are identified as segments. The segmented images are then forwarded to a contour determining unit 22. The contour determining unit extracts the contours, i.e. the boundaries of the coloured areas, step 30, and selects interest points on the contours of the objects in each image, step 32. In the described embodiment the interest points only include detected junction points, i.e. points where two different contours meet, but they can also include other points of interest like corners of an object and random points on a contour either instead or in addition to junction points. In FIG. 1A-C this is shown for images I₁, I₂ and I₃ respectively. The images include a first topmost object 10 a second object 12 distanced a bit further away and a third object 14 furthest away from the capturing point of the camera. In FIG. 1A are shown junction points J₁ and J₄, where the contour of the second object 12 meets the contour of the third object 14, and junction points J₂ and J₃, where the contour of the first object 10 meets the contour of the second object 12. In this figure the contour of the first object 10 does not meet the contour of the third object 14. In FIG. 1B the objects have been moved somewhat in relation to each other and hence there are a number of new junction points detected, where junction points J₅ and J₁₀ are provided for the second object 12, where the contours of the second 12 and third object 14 meet, the junction points J₆ and J₉ are provided for the first object 10, where the contours of the first 10 and second objects 12 meet and junction points J₇ and J₈ are provided for the first object 10, where the contours of the first 10 and third 14 objects meet. In FIG. 1C, the objects have been moved further from each other so that only the first 10 and third object 14 overlap each other. Here junction points J₁₁ and J₁₂ are provided for the first object 10, where the contours of the first 10 and third 14 objects meet.

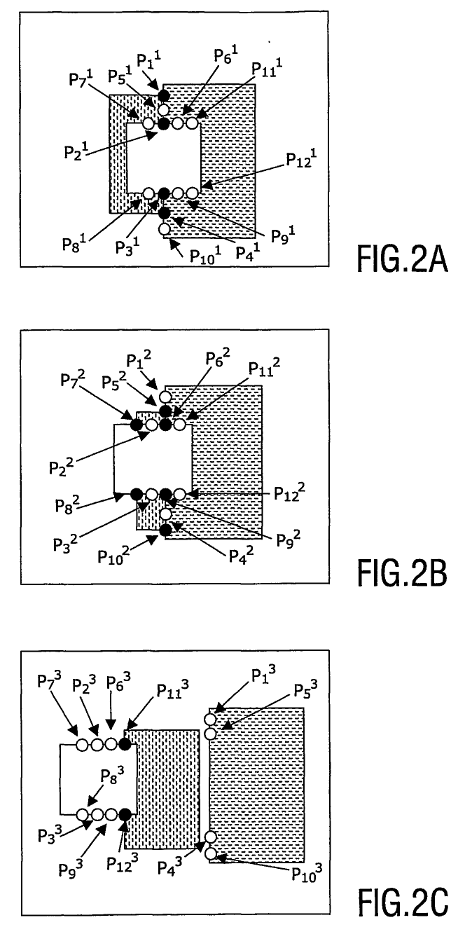

When the contour determining unit 22 has done this it goes on and associates, for each extracted contour, interest points to corresponding reconstructed points, step 34. This is done through reconstructing the interest points in the world space by means of three-dimensional reconstruction. This can be done according to a segment based depth estimation, for instance as described by F. Ernst, P Wilinski and K. van Overveld: “Dense structure-from-motion: an approach based on segment matching”, Proc. ECCV, LNCS 2531, Springer, Copenhagen, 2002, pages II-217-II 231, which is herein incorporated by reference. It should however be realised that this is only one and the presently considered preferred way of doing this. Other ways are just as well possible, i.e. The junction points are here defined to “belong” to the topmost object, i.e. the object closest to the capturing point. This means that junction points J₁ and J₄ belong to the second object 12 and junction points J₂ and J₃ belong to the first object 10. All the reconstructed points related to an object are then projected into the different images at a position determined by the apparent movement of the object, step 36, i.e. based on the depth and displacement of the camera from image to image. This is shown in FIG. 2A-C, where the projection P₁-P₁₂ of the reconstructed points corresponding to junction points J₁-J₁₂ are projected into all of the images. All the reconstructed points are thus projected into the first image I₁ as shown in FIG. 2A, where the reconstructed points emanating from other images than the first have been placed on the contour of an associated object determined by the speed of movement of that object. Thus projections P₁¹-P₄¹ are all placed at or in close proximity of the positions of the corresponding junction points J₁-J₄. The projections P₅¹ and P₁₀¹ which are associated with the second object are thus placed in positions of the second object in the first image I₁ corresponding to the position in the second image I₂, while the projections P₇¹-P₉¹ are associated with the first object and thus projected onto this object in the first image I₁ corresponding to their positions in the second image I₂. The projections P₁₁¹ and P₁₂¹ from the third image I₃ are also projected onto the contour of the first object in the first image I₁ at the positions corresponding to their position in the third image I₃, since they “belong” to the first object. This same procedure is then done also for image I₂ and image I₃, i.e. projections associated with the first object are projected on the contour of this object while projections associated with the second object are projected on this object, which is shown in FIG. 2B and FIG. 2C respectively. Projections of reconstructed points that are not junction points are then distinguished from reconstructed points that are junction points, in each image, which is indicated by the junction points being black while the other reconstructed points are white.

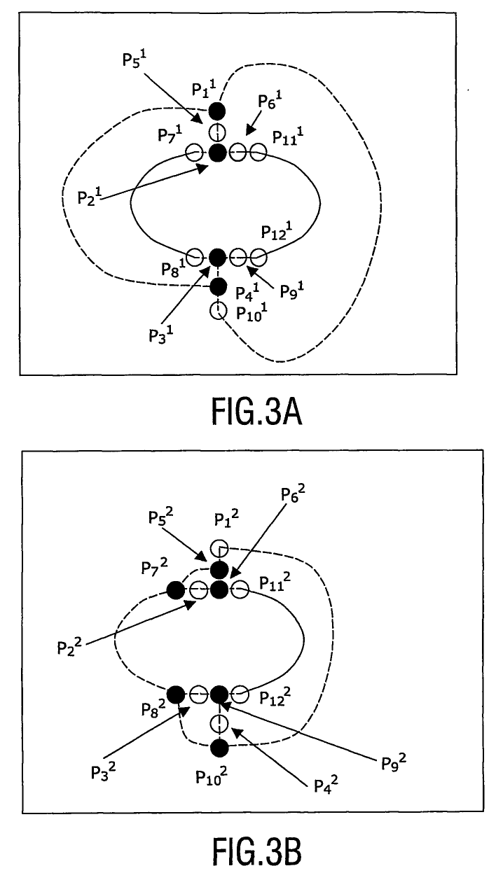

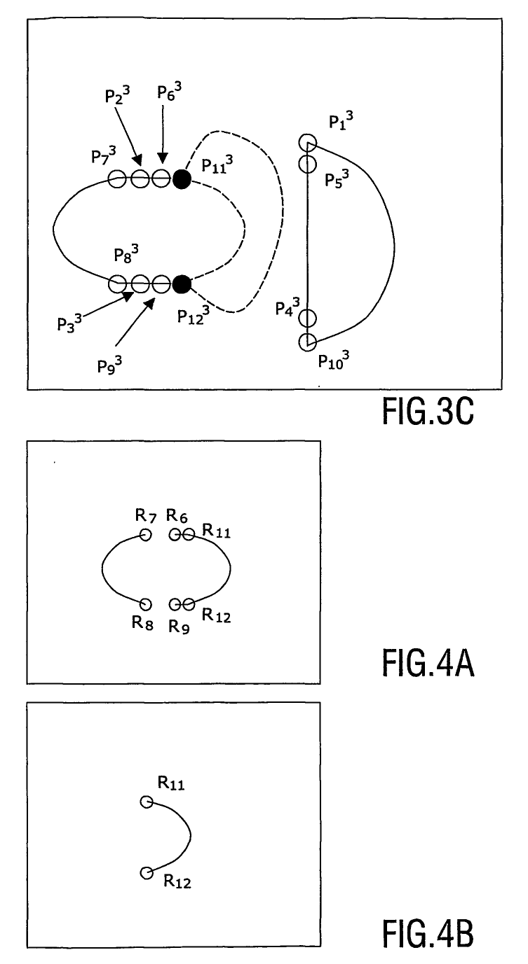

Thereafter the projected reconstructed points that are not projected at junctions are linked together in a first set of links, step 38, and the projected reconstructed points projected to junctions are linked together in a second set of links, where a projected reconstructed point that is an end point of a link in the first set is linked to a projected reconstructed point in the second set using a link in the second set The first set of links is considered to include well-defined links, i.e. the links only link points that are well defined and where there is no question about which contour they belong to. The second set of links is considered to include non well-defined links, i.e. the links are connecting points, where at least one point in such a link is non-well defined. That is it is not directly evident to which contour such a point belongs. The linking is here performed in the two-dimensional domain of the different images. This is shown in FIG. 3A-C for the images shown in FIG. 2A-C. In FIG. 3A, the projected reconstructed points P₇¹ and P₈¹ have been linked together with a link in the first set and projected reconstructed points P₁₁¹, and P₁₂¹ have been linked together with a link in the first set. Also the projected reconstructed points P₆¹ and P₁₁¹ as well as the projected reconstructed points P₉¹ and P₁₂¹ have been linked in the first set since these links are between reconstructed points not projected at a junction. These links of the first set are shown with solid lines. The projected reconstructed point P₁¹ is linked to projected reconstructed point P₄¹, projected reconstructed point P₅¹ and projected reconstructed point P₁₀¹. Projected reconstructed point P₅¹ is also linked to projected reconstructed point P₂¹, which in turn is linked to projected reconstructed points P₇¹ and P₆¹. Projected reconstructed point P₃¹ is linked to projected reconstructed points P₈¹, P₉¹ and P₄¹, which point P₄¹ is further linked to projected reconstructed point P₁₀¹. All these latter links are a second set of non-well defined links, which are shown with dashed lines.

In the same manner FIG. 3B shows how a first set of well defined links provided for image I₂, where projected reconstructed point P₁₁² is linked to projected reconstructed point P₁₂² with a link of the first set, which is shown with a solid line. Projected reconstructed point P₁² is linked to projected reconstructed points P₅² and projected reconstructed point P₁₀². Projected reconstructed point P₅² is also linked to projected reconstructed point P₆² and projected reconstructed point P₇². Projected reconstructed point P₆² is linked to projected reconstructed points P₁₁² and P₂² and projected reconstructed point P₇², which point P₇² is also linked to projected reconstructed point P₂² and projected reconstructed point P₈². Projected reconstructed point P₈² is further linked to projected reconstructed point P₃² and projected reconstructed point P₁₀². Projected reconstructed point P₃² is further linked to projected reconstructed point P₉², which is also linked to projected reconstructed points P₁₂² and P₄². Projected reconstructed point P₄² is linked to projected reconstructed point P₁₀². All of these latter links are links of the second non-well defined set, which are shown with dashed lines.

In the same manner FIG. 3C shows the well-defined links in the first set for image I₃, where the first projected reconstructed point P₁³ is linked to the projected reconstructed points P₁₀³ and P₅³, which latter is also linked to the projected reconstructed point P₄³. The projected reconstructed point P₄³ is also linked to projected reconstructed point P₁₀³. Projected reconstructed point P₇³ is linked to projected reconstructed point P₈³ and projected reconstructed point P₂³, which in turn is linked to projected reconstructed point P₆³. Projected reconstructed point P₈³ is also linked to projected reconstructed point P₃³, which in turn is linked to projected reconstructed point P₉³, where all these links thus are well-defined and provided in the first set which is indicated by solid lines between the projected reconstructed points. The projected reconstructed point P₁₁³ is linked to projected reconstructed point P₁₂³ with two links, where a first is associated with the contour of the first object and a second is associated with the contour of the third object, as well as to projected reconstructed point P₆³. Projected reconstructed point P₁₂³ is also linked to projected reconstructed point P₉³. All these latter links are non-well defined links of the second set, which is shown with dashed lines.

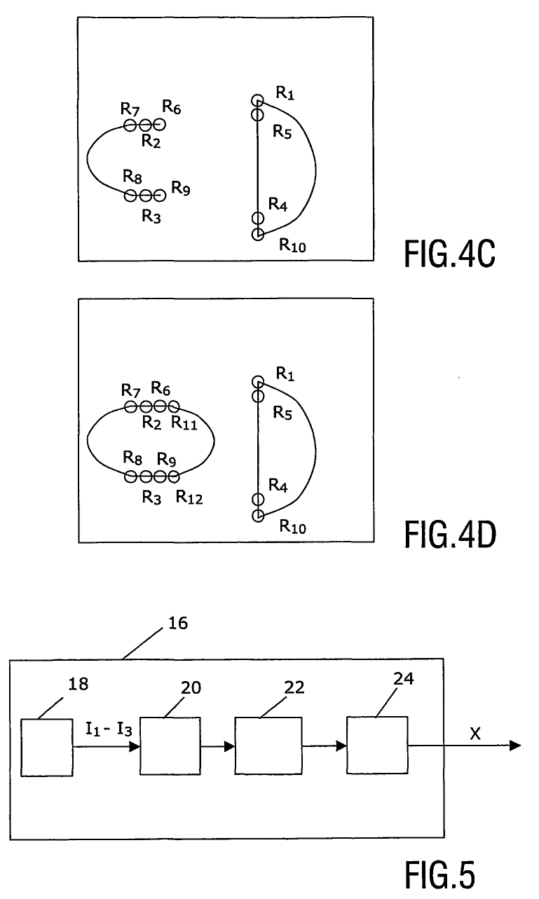

The links of the first set can then be used for recovering the contour of an object, but also the second set of links include information that can help the establishing of the contour of an object. The links of the first set are then to be used through combining them in order to obtain a complete contour of an object. This is then done with the reconstructed points in the world space. This combination is shown in FIG. 4A-D, where FIG. 4A shows the links according to the first set in FIG. 3A, FIG. 4B shows the links according to the first set in FIG. 3B and FIG. 4C shows the links according to the first set in FIG. 3C. In order to obtain contour information, the links of the first set are thus combined, step 40, which enables the obtaining of a complete contour of the first and second objects. This is shown in FIG. 4D, where the reconstructed points R₇, R₂, R₆, R₁₁, R₁₂, R₉, R₃ and R₈ have been combined for establishing the contour of the first object and the reconstructed points R₁, R₅, R₄ and R₁₀ have been combined for establishing the contour of the second object. As can be seen in FIG. 4D the whole contour of the first and second objects are then determined.

The thus combined links are then transferred together with the images I₁-I₃ from the contour determining unit 22 to the coding unit 24, which uses this contour information in the coding of the video stream into a three-dimensional video stream, step 42, which is performed in a structured video framework using object based compression and can for instance be MPEG4. In this case the linked reconstructed points can then be used for deriving the boundaries of video object planes. The coded images can then be delivered from the device 16 as a signal x.

There can in some instances be more than one link provided between well-defined points according to the first set. In this case the normal practice is to discard the projected reconstructed point, which has more than three such links and thus only to keep points if there are two or fewer links to a well defined projected reconstructed point.

Another case that might arise is that projected reconstructed points may overlap in a given image. In this case the links are not well defined and the points are thus not provided in the first set.

Another case that might arise is that reconstructed points may correspond to actual junctions in a scene, like for instance texture or a corner of a cube. These are then considered to be natural junctions, which should appear in most or all of the images. When such reconstructed points are consistently projected at a junction in most frames, they are therefore considered to be natural junctions. These natural junctions are then considered as well defined reconstructed points and thus also provided in the first set of links, in order to establish the contour of an object.

Yet another case is the case when a projected reconstructed point has no contour connected to it in an image, then it is said to be occluded in the image in question. Any links that are well defined related to this projected reconstructed point are then at least partially occluded in the image.

Many units of the device and particularly the image segmenting unit and contour determining units are preferably provided in the form of one or more processors together with corresponding program memory for containing the program code for performing the method according to the invention. The program code can also be provided on a computer program product, of which one is shown in FIG. 7 in the form of a CD ROM disc 44. This is just an example and various other types of computer program products are just as well feasible, like other types and forms of discs than the one shown or other types of computer program products, like for instance memory sticks. The program code can furthermore be downloaded to an entity from a server, perhaps via the Internet.

With the present invention there are several advantages obtained. It is possible to obtain the complete contour of an object even if the whole object is not completely visible in any of the related images. It suffices that all the different parts of it can be obtained from the totality of the images. Because a limited number of points are used, and in the described embodiment only junction points, the computational power needed for determining a contour is kept fairly low. The invention is furthermore easy to implement, since all points are treated in a similar manner. The invention is furthermore robust, since incorrectly reconstructed points and other anomalies can be easily identified and corrected. As mentioned before the invention is furthermore well suited for combining with MPEG4.

There are several variations that can be made to the present invention. It does not have to include a camera. The device according to the invention can for instance receive the interrelated images from another source like a memory or an external camera. As mentioned before the interest points need not be junction points, but can be other points on a contour. The provision of the first and second set of links was provided in relation to the projected reconstructed points in the two-dimensional space of the images. It is just as well possible to provide at least the first set of links and possibly the second set of links directly in the three-dimensional world space of the reconstructed points. It is furthermore not strictly necessary to determine the depth of the (points on the) contour at the time of associating interest points with reconstructed points, it can for instance be done earlier, like when performing the segmenting. It is furthermore possible to also use techniques that are also based on movement of objects from scene to scene. The invention is furthermore not limited to MPEG4, but can also be applied in other object-based compression applications. The invention is thus only to be limited by the following claims.

1. Method of providing contour information related to images, comprising the steps of:
obtaining a set of interrelated images (I₁, I₂, I₃), (step 26),
segmenting said images, (step 28),
extracting at least two contours (10, 12, 14) from the segmentation, (step 30) selecting interest points (J₁-J₁₂) on at least some of the contours, (step 32),
associating, for said extracted contours, interest points (J) with corresponding reconstructed points by means of three-dimensional reconstruction, (step 34),
projecting the reconstructed points (P₁-P₁₂) into each image, (step 36), and
linking, for each image, reconstructed points that are not projected at a junction point between different contours or their projections to each other in order to provide a first set of links, (step 38), such that at least a reasonable part of a contour of an object can be determined based on the linked points.

2. Method according to claim 1, wherein the step of linking in the first set of links comprises only providing links between reconstructed points or their projections associated with the same contour.

3. Method according to claim 1, where the interest points comprise junction points (J), where a junction point is provided at a location where two contours border each other.

4. Method according to claim 1, further comprising the step of combining, for a contour, the links in the first set of links provided in relation to each image for obtaining at least a reasonable part of a complete contour of an object (step 40).

5. Method according to claim 4, wherein the step of combining comprises only combining the links to points that have less than three links.

6. Method according to claim 5, further comprising the step of discarding, for each image, at least some of those reconstructed points or their projections to which links are provided from more than two other reconstructed points or their projections.

7. Method according to claim 1, wherein the step of linking comprises linking, for each image, reconstructed points that are projected at a junction or their projections to reconstructed points or their projections in a second set of links.

8. Method according to claim 1, wherein the reconstructed points that are projected at a junction in a majority of the images or their projections are linked in the first set of links.

9. Method according to claim 1, wherein the reconstructed points are provided in a three dimensional space.

10. Method according to claim 1, wherein the images are provided in a two dimensional space.

11. Method according to claim 1, further comprising the step of determining the actual motion of contours from image to image before projecting reconstructed points into an image.

12. Method according to claim 4, further comprising the step of coding the images, (step 42), where the information about the linked reconstructed points is used in the coding.

13. Apparatus (16) for providing contour information related to images, comprising:
an image obtaining unit (18) arranged to obtain a set of interrelated images, and
an image segmenting unit (20) arranged to segment said images, and
a contour determining unit (22) arranged to:
extract at least two contours from the segmentation made by the segmentation unit, select interest points on the contours of each image,
associate, for each extracted contour, interest points with corresponding reconstructed points by means of three-dimensional reconstruction,
project the reconstructed points into each image, and
link, for each image, reconstructed points that are not projected at a junction between different contours or their projections to each other in order to provide a first set of links, such that at least a reasonable part of a contour of an object can be determined based on the linked points.

14. Computer program product (44) for providing contour information related to images, comprising a computer readable medium having thereon:
computer program code means, to make the computer, when said program is loaded in the computer:
obtain a set of interrelated images,
segment said images,
extract at least two contours from the segmentation,
select interest points on at least some of the contours,
associate, for said extracted contours, interest points (J) with corresponding reconstructed points by means of three-dimensional reconstruction,
project the reconstructed points into each image, and
link, for each image, reconstructed points that are not projected at a junction point between different contours to each other or their projections in order to provide a first set of links, such that at least a reasonable part of a contour of an object can be determined based on the linked points.
